(19) United States
(12) Patent Application Publication
(10) Pub. No.: US 2019/0297786 A1
(43) Pub. Date: Oct. 3, 2019

(54) VERTICAL GROWING SYSTEM FOR CAPTURING THREE-DIMENSIONAL SPACE

(71) Applicant: Jeffrey Scott Rash, Valley City, ND (US)

(72) Inventor: Jeffrey Scott Rash, Valley City, ND (US)

(21) Appl. No.: 15/942,496

(22) Filed: Mar. 31, 2018

(51) Int. Cl. A01G 9/02; A01G 27/00; A01G 27/06; A01G 31/06

(52) U.S. Cl. CPC A01G 9/023; A01G 31/06; A01G 27/06; A01G 27/008

(57) ABSTRACT

A vertical growing device that uses three-dimensional space effectively, resulting in an inexpensive way to grow plants in a modicum of space. The system is comprised of root bucket (100) with trunk (101) upon the bottom of root bucket (100) and rising out of the lid of root bucket (100.) The part of trunk (101) above the lid has a number of holes which allow the attachment of plumbing fittings, such as street elbows (104) and or other plumbing fittings. Attached to street elbows (104) are branch tubes (103) with grow bays (102.)

### CROSS-REFERENCE TO RELATED APPLICATIONS

This application claims the benefit of Provisional Application No. 62/505,402 filed on May 12, 2017 by the present inventor.

### BACKGROUND

### Prior Art

The following is a tabulation of some prior art that presently appears relevant:

U.S. Patents

| Patent Number | Kind Code | Issue Date | Patentee |
|---|---|---|---|
| 6,612,073 | B1 | 2003 Sep. 2 | Powell, Marks |
| 6,840,008 | B1 | 2005 Jan. 11 | Bullock, Roberts |
| 2016/0135398 | A1 | 2016 May 19 | Mathieu, Gillbanks |

Foreign Patent Documents

| Foreign | Cntry. | Kind | | App or |
|---|---|---|---|---|
| Doc. Nr. | Code | Code | Pub. Date | Patentee |
| GB988458 | GB | A | 1965 Apr. 7 | Marcan |
| JP2009065926 | JP | A | 2009 Apr. 2 | Shigemori |

### The Continued Age of Agriculture

The human race, every man, woman and child, still depends upon a farmer to feed them. From the perspective of life and food, humanity is still very much in the age of agriculture. Certainly humanity has mastered this age of agriculture well enough to feed our present population. It can't be argued that humanity does not produce enough food to feed our population. The pitfalls that cause starvation in such vast areas of the world relate to lack of transportation systems, poor politics, sheer greed, war and particularly, the use of food as a weapon. The fact that food still falls prey to all these problems, is deeply illustrative that we rest firmly in the midst of the agricultural age. In this age we will remain—until someone invents a human that runs on batteries.

Humanity is still a farming race, but a new page in humanity's continuing age of agriculture, beckons us to turn it. How will humanity feed itself as we strain to leave the cradle of our race? How will we live on the moon, colonize the planets of our solar system and someday travel to new stars? This age of migration from our cradle cannot begin, until our race learns new methods of farming.

### Feeding Billions

And what of the billions here on Earth? Many see too many people, not enough room and not enough food. Many say it's impossible to feed everyone and resign themselves to the horrific death of millions, perhaps even billions. Others suggest that terrible wars, even world wars, will be fought over food and the limited resources to grow it . . . .

But humanity has always risen to our most pressing challenges. The bigger the challenge, the more likely we are to meet it. Life on the moon, a colony on Mars and the fate of billions IS humanities biggest challenge to date- and one we must meet.

Many noble attempts have succeeded in boosting food production to truly amazing levels; levels thought to be impossible fantasy at the beginning of the last century are routinely achieved today. But all of these methods so far focus upon boosting the production of traditional, two-dimensional farms. Traditional farmland is of course limited and with every foot of concrete laid, every yard of asphalt paved, there is less and less land for farming.

Cities themselves offer no refuge for the would be farmer, save very expensive attempts at urban farming. Greening a city suffers from the fact that space in any city is incredibly expensive. In Japan, people are signing multi generational loans, committing themselves, their children and their grandchildren to crushing debt. The process of converting abandoned buildings and turning them into improvised greenhouses suffers from this approach. All attempts at large scale urban farming to date carry the vice of great expense. The startup costs of even a highly touted shipping container greenhouse, said to make growing possible anywhere, surpasses $100,000 US. Few have enough money to purchase technology that is essentially still in the experimental stages.

Deserts seem to offer many a way to alleviate the possibility of global starvation by converting the vast acreages of desolation around the world into traditional farm land. But the problem here again is one of expense in resources. Desert farmers competing for the same water resource as cities is not an answer.

The hope of many is in bringing increasing yields on farmland that is already in production. Indeed, an examination of current technology reveals this to be the wisest tactic to feed the world. In places where modern agriculture is practiced, we see the greatest examples of what science, industry and machinery can do. The sheer amount of yield per acre in the American Midwest is an unrivaled and unprecedented example of how much modern agriculture methods can improve an acre of land in terms of yield. But surely there are limits to this. While we are not yet at the pinnacle of what modern agricultural methods can provide, the tremendous gains of the past 100 years will certainly not be repeated by changing seed, introducing more pesticides, insecticides and fertilizers and building ever larger farm vehicles.

And many worry over the unseen costs of modern agricultural methods. What are we doing to the environment by adding more and more chemicals to our fields? What are we doing by modifying our plants to resist the chemicals sprayed upon them in an effort to kill weeds and insects? What are the effects of altering the very nature of the plants that sustain us? Many worry that humanity is venturing into an area so unfamiliar, that we are entering an age of Frankensteinian proportions. Many worry that if the path to greater amounts of food is more and more of modern agriculture, than we may well run into consequences that are deeply unintended and truly unforeseen. Though it is true that our modern foods are safer than ever before, can we say it will always be so?

### The New Art of Xenofarming

And what of that new age of space travel, colonizing new worlds and growing food in inhospitable places? Right now, keeping less than a dozen people in orbit about the Earth costs billions. Ridiculous amounts of cargo, much of it food, must be lifted to the International Space Station on a regular basis. Until that changes, man will be confined to orbit only his home world in tiny, crowded space stations.

Living on a dead world like Mars presents an order of magnitude in difficulty when compared to feeding the population of a space station. Mars is eight or more months of flight time when Earth and Martian orbits are perfectly aligned for the shortest trip possible. It can take a year or more to reach Mars when orbits are opposed. With distances like that, the Martian pioneers must bring with them the ability to farm in ways that don't now exist.

Even a crew of Astronaut researchers can't go to Mars with our current agricultural technology. How are they to be fed on the eight month journey to Mars? Eight months of food, even “space food,” represents a huge amount of cargo! And how are they to be fed while working upon the surface of Mars and the journey back? A ship that could contain that much food would be 99.9% food and the fuel needed to push all that mass to Mars and back. It would be a truly ridiculous ship; the virtual embodiment of James's Giant Peach in space.

And what of the quality of life aboard a ship like that? Would sanity be an issue after eating eight months of space food? Hotdogs and cheese might store well, but in the end, what would a fresh carrot, a ripe tomato and crisp salad lettuce mean to you? When taken together, the trip is impossible. No ship can be made that big, no engine so efficient, that flight will be significantly reduced. And humans are not robots. We are not constructed to live in space and eat space food squeezed from a tube. We are constructed to live in the many different environments of Earth, not the sterile one of space.

Humans are farmers and always will be. We need fresh food to keep us going. We need the satisfaction that fresh food brings us. Wherever humanity travels, we will first and foremost travel as a farmer. Clearly, farming must change if the future is to see mankind leave Earth and spread across new worlds.

### Traditional Farming Improvements

And how do we increase the amount of available farmland here on Earth? Is that possible without using massive amounts of fresh water, water already in short supply in many cases? And how do we increase yield per acre without more chemicals, more drastic changes to our seeds and ever larger machines?

Many have tried to answer the problem of limited and shrinking land space by coming up with an alternative way of farming. At one point in humanity's history, someone discovered that hills may be terraced. Looked at through the lens of history, this was the first successful attempt at vertical farming. With the invention of pottery, humanity found that a miniature garden or even a miniature farm could be brought into a city. The Hanging Gardens of Babylon no doubt relied deeply on terraces and pottery. These technologies have served humanity well through the ages and are still in use today.

But in modern times, our continued advances have allowed the vast amount of people to largely abandon farms and gardens. We have specialized in our occupations and a garden is now seen as a luxury and a burden that many can afford to do without. And in truth, they are right. A garden takes back breaking work. Ground must be tilled, seeds planted and barriers erected. It then must be watered and weeded, tended and guided, protected and nurtured. The amount of time spent in one weekend just preparing a small patch of ground to plant, is more than a year's time spent shopping the produce isle.

But clearly, it would only help if people could supplement their diet with food from a personal garden. Having a garden with vine fresh vegetables cuts down dramatically on food waste. Every year, drastic amounts of food are thrown out due to spoilage. It is estimated that up to 30% of fresh food grown in America is thrown out each year; even with modern transportation, modern supermarkets and modern refrigeration methods.

Many see a personal garden as a way to eliminate all this waste and lessen the pressure upon farm fields to produce more and more food all year round. And there is no argument that having a garden is the way to give fresh food the longest shelf life and best taste. But modern life and its pressures prevent many from raising even a fraction of their own food. And there are many intangible benefits besides fresh food in the effort of planting, raising and harvesting a garden. Gardening brings much needed exercise, relief from boredom and educates people on just what it takes to grow food. We are natural creatures, meant to be outside, meant for the sun upon our skin. We are creatures of the land, of the soil and of dirty hands. As a race, we will always be farmers. To take us from the soil, has damaging consequences. It is a needed thing then, to bring the soil to us.

### The Art of Nontraditional Growing

Many have tried to maximize the efficient use of space and resources by coming up with a system that turns flat ground into a “tower of food.” Quite a number of vertical growing systems have been developed in the past and one look at the prior art will prove that it is a crowded field. But the prior art of vertical growing suffers from multiple problems. Many vertical systems lack strength or they are expensive or are limited in the types of plants they can grow—and this is just a few of their issues. While many systems try to reduce the initial cost burdens, they can't do much about the fact that they still require large outlays of resources in the form of time, labor and or expensive support systems. Further, many make no provision for use indoors or in a small garden, single-unit approach. Most systems are designed for large scale growing only. And only a few make provision for tool assisted harvesting or robotic growing. Truly, most systems suffer from one or more of the following problems.

(a) Expense, many systems are difficult to fabricate and expensive to purchase. Prior art systems researched and meant for home use exceed $10,000 retail! And even systems made for industrialized growing retail for $200 or more per system- and are not self sufficient.

(b) Delicate, many systems can't stand up to the abusive farm environments of modern agriculture. Most are made from materials that would be more at home in a folding card table or a TV dinner stand.

(c) Complicated, almost every commercial grade system depends upon external pumps, control systems and a greenhouse like environment. Systems that are self contained are rare and their costs are beyond the common person's budget.

(d) Arduous, many systems can't grow from seed to harvest in the same system. This means they must be planted as seed in one place, raised to seedlings in another and finally transferred to a third system to finish.

(e) Laborious, systems require constant human labor to maintain them. Most systems give no thought to using automation to reduce the need for labor.

(f) Limited, most systems are intended for only one type of crop. This is why so many systems concentrate upon lettuces and micro greens. Lettuces and micro greens are short growers and the low rise growing beds and lights cannot support taller plants.

Humanity will not travel to Mars with any system that requires the plant to be moved from system to system. Nor will humanity feed the burgeoning billions of our Earth with a system that requires constant movement. The man hours are just too inefficient with such a system. What is needed is one system that will grow nearly any type of crop from seed to harvest in a rugged, farm like device. The prior art lacks anything that can be used by the poorest denizens of our planet to stave off starvation and prevent malnutrition and as such, leaves them vulnerable.

Current systems cannot be easily moved in times of war or disaster and continue to grow a families food. The prior art lacks anything that can be concealed to prevent theft, pillage or outright destruction by tyrants. The prior art lacks anything that is capable of being used indoors, outdoors, in space or on Mars. It does not allow a handicapped person or a child or the elderly to garden easily. The prior art lacks anything that can be setup on a weekend by busy adults to raise food with little further attention. They can't be used on a patio, a small backyard or an unused corner of a house or apartment. Professional systems all require huge investments of time, labor, money and support systems. The art then must be advanced by a leap, not a slow progression of improvements. We shall not see a bright future with the current state of the art.

U.S. Pat. No. 6,612,073

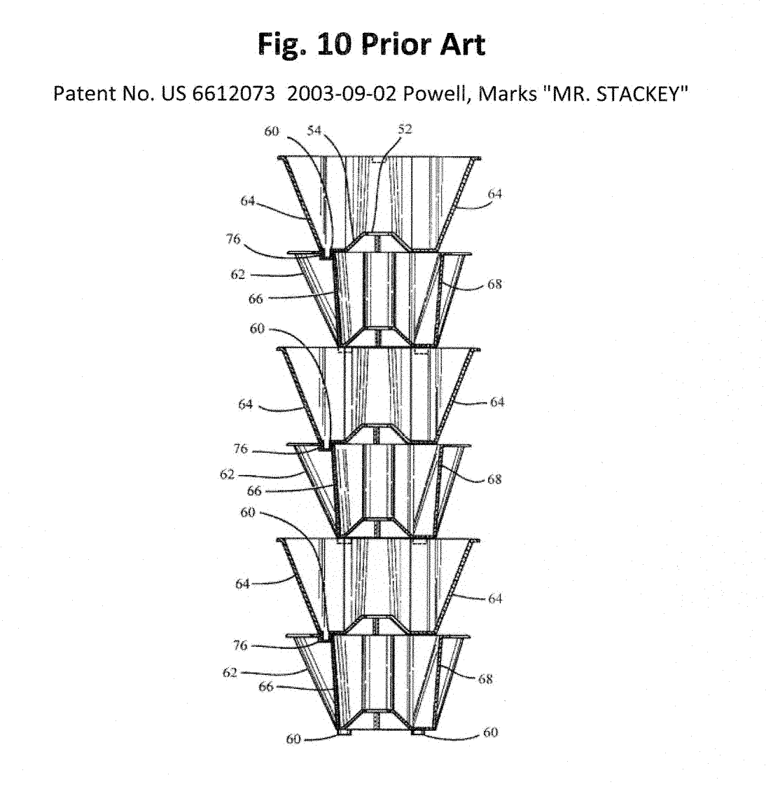

For instance the product commonly termed “MR. STACKY,” and issued U.S. Pat. No. 6,612,073 will never be effectively used except outside. A drawing of the system is referenced as FIG. 10 herein. A first tier composed of six plant pockets is placed upon the ground. The next tier is shifted a number of degrees and placed atop the first tier, making room for six more plants. Tiers are shifted and stacked one upon the other, up to a height of roughly five feet. While the system is relatively inexpensive in cost, its design requires that it have a vertical spike driven into the ground or it suffers from being prone to toppling. This central spike means the system can't be moved to another location without uprooting the plants. And the system is truly designed for outside use or in a dedicated growing space where soil and water spillage are not an issue. A drawback that is easy to miss, even to see as a boon, is that the system essentially works from the top down and the outside towards the center. This top down, outside-in design approach will be expanded upon later, but every system of the prior art seems to have at its core the same design approach. As such, they all limit the number of plants that can grow in them by reaching from the outside-in. The user of the system has a limited plant choice by the size of the growing bays. The Mr. Stacky system further places plants in damage of heat stress if not watered often. The small pockets do not allow for water to be stored effectively in the soil and root system of the plants. Further, the small pockets don't allow carrots and other tubers and vegetables that vine or grow laterally to be used with the system.

U.S. Pat. No. 6,840,008

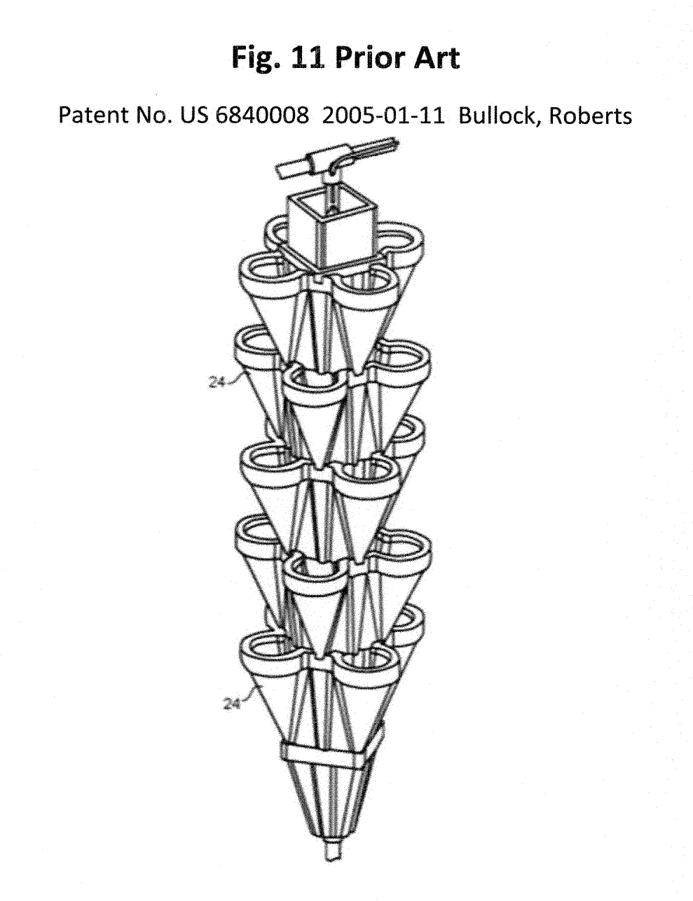

Another vertical garden attempt is found in U.S. Pat. No. 6,840,008, issued to Bullock and Roberts on 2005 Jan. 11. A drawing of the device is included herein as FIG. 11. It shows a vertical structure using conical “pockets” to hold plants. The system is unitized into one body. While the system is certainly strong enough, it suffers many of the same problems as the previous device, plus it is considerably more expensive. It cannot be easily moved, especially when filled with wet soil and plants. It must be manually maintained and attended to, with seemingly little thought towards automation. The conical pockets appear to be designed for use with net baskets, meaning plants must be sprouted in one system, moved to another for a time and then finally planted into the conical pockets. It should further be noted that this design shows on the Euro Patent website as lapsed into the public domain for nonpayment of patent fees.

Great Britain Patent No. GB988458

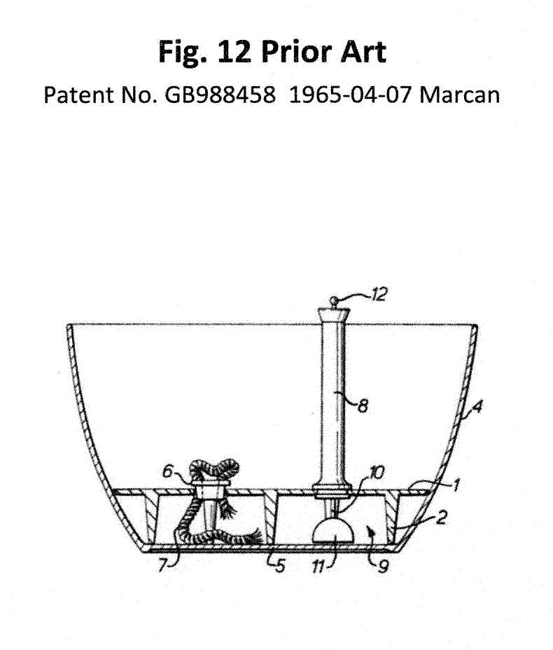

In answer to the laborious tasks involved with nontraditional farming and growing, many have sought to at least automate the time consuming task of watering plants. Many passive designs have been proposed. For instance, a self watering system was granted a patent in 1965. David Marcan was the Inventor and the patent was granted on Apr. 7, 1965. The patent issued in England, No. GB988458, uses a short wick made of cloth to transfer moisture from a reservoir to the plant held in the container. FIG. 12 includes a drawing of the device. Examination of this patent and additional research will easily show the use of water wicking materials goes back many decades and has certainly passed into common knowledge of one skilled in the art. However, the wicks used in prior art are short, transferring moisture over a small distance. Some wicks may be round, others flat or even hollow, but all are relatively short, measuring 5.11 inches or generally much less.

It did not take long for people to realize they could use a wick based system as described above with repurposed, disposable, plastic drinking bottles. Multiple designs can be researched, stretching back across the decades. Plastic drink containers with short wicks used as seed germination beds is decades old. Repurposed or otherwise recycled bottles of polyethylene, polypropylene or nearly any other plastic material, are ideal for the harsh environments of farming and growing. Plastics resist the effects of most chemicals, fertilizer, and soil medias. Plastics further have excellent strength to weight ratios and are cheap, even free for the taking. For these reasons, they have long been used by gardeners and professional growers alike, as gardening “pots,” for seed starters and as hydroponic media containers, just to name a few of their uses in the art.

Japanese Patent No. JP2009065926

A patent was issued in Japan on Apr. 2, 2009 to Shigemori Motoko. Patent No. JP2009065926 details the use of PET bottles and a wick based system to grow vegetables in a vertical fashion. A copy of this design is shown herein as FIG. 12. The initial claims in Shigemori's application that using plastic bottles with and without wicks was a new use in growing applications, were denied because the Patent Examiner felt both were well established in the prior art. However, a limited patent was granted for the attachment of drink bottles to the system by their threads. The attachment device was essentially a female threaded connector that allowed the PET bottle to be connected directly to the trunk of the device. Further, the patent shows as no longer in force due to nonpayment of fees. It should be noted then that the use of plastic drink bottles with a short wick as described in Motoko's patent, is nothing new to the art.

US Patent No. US2016/0135398

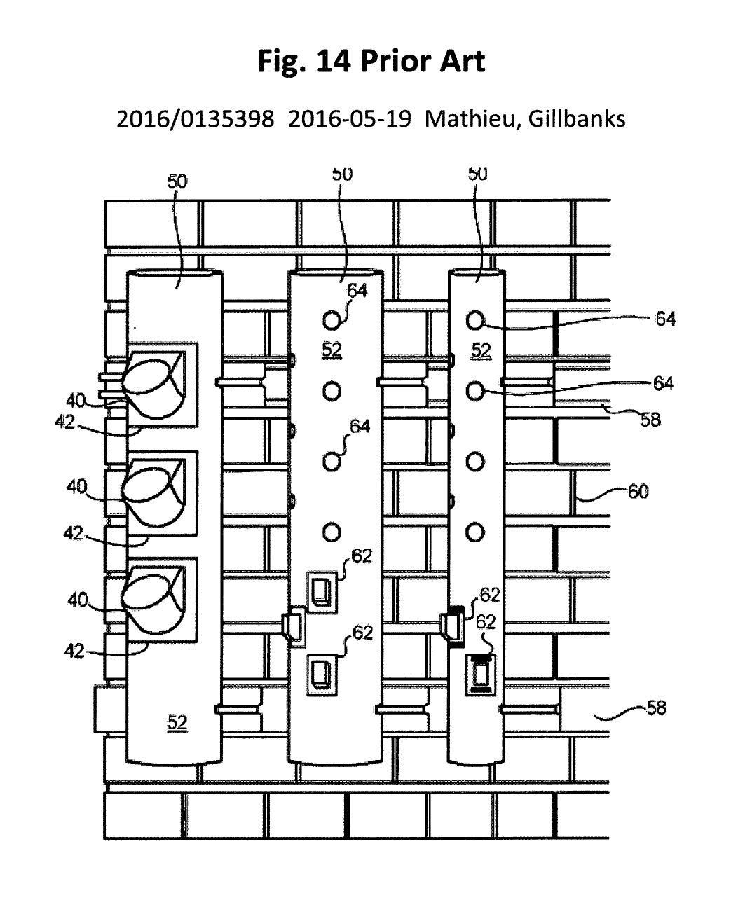

Patent No. US2016/0135398 was given on May 19, 2016 to Mathieu and Gillbanks and was assigned to Bellwether Innovations, LLC. A drawing of this device is seen herein as FIG. 14. This patent describes a vertical based system using what the Inventors call “plant receptors.” These plant receptors allow the user to attach and remove plants at will to the vertical system. The system uses flanges to attach the plant receptacles. In practice, the system might be used with hydroponic media alone, but it is clear the intention here was to create portals for use with hydroponic net baskets. As such, it falls prey to the same labor and expense issues that all other previous systems fall prey to. The amounts of time needed to sprout seedlings in one system, then transfer to another system for juvenile growth and then to finally place them into the vertical system, is prohibitive. Another problem with this system is that one must purchase the plant receptacles from the vendor. These are of no small cost and represent a significant, recurring, expense. Atop this are all the support systems that must be maintained along with the system itself. The need for a greenhouse environment, along with pumps, net baskets, nutrient tanks and piping, seems to be clearly assumed.

### Flat Thinking Bias

The one common problem that runs like a connecting thread through each of the systems in the prior art is that each is the reverse of nature's perfect growing system, the tree. Trees have strong roots, deep in the ground. Their main function is to prevent the tree's toppling and to provide water and building blocks for growth. Trees further have rigid trunks, upon which are born the weight of the branches. The trunk acts as a conduit for moisture and materials taken from the soil to the branches and these branches reach out into the three-dimensional space around a tree. This allows a branch to fulfill its primary function of capturing more space and thusly, more sunlight, for the tree's use. And of course a branch acts as a conduit for water and nutrients from the roots.

Each vertical growing system reviewed during this application's research phase was revealed to be the opposite of a tree. Instead of attempting to get out and away from the trunk the way a tree does, all prior art seems to want to get as close to the center of the trunk as possible. This approach leaves these system with many drawbacks. First, it limits the size of grow bays, because as one works with an outside-in approach, one naturally becomes aware of the limited space in the trunk.

This thinking shows a bias that appears everywhere in the prior art. The most important resource as seen by a traditional farmer, is water. Getting into the soil where the moisture is found, is crucial to traditional farming. The resource of light is so taken for granted in traditional flat farming, that it is not even considered. But the designer of the tree knew better. Trees can live on very little moisture and poor soils. The most important resource to a tree, is light.

Nontraditional growing systems show this bias of “flat thinking” in their designs by working from the outside in and staying close to the moisture source. But a tree grows in three dimensions, because its designer knew light is the crucial resource. In truth, traditional flat farming still uses three dimensions, but this is a very easy truth to miss. A tree's growth essentially captures the limited resources of sunlight by capturing as much of the three-dimensional space around the tree as is practical. It should be noted then that water and nutrients are not what make a plant grow. It is light. Light and the maximum capture of it are what make a plant and a tree grow sound and strong. Supply a plant with rich soil and all the water it could want and nothing will happen. Add light, and the plant will grow. Add more light, and it will grow faster. To date, Inventors have focused on the wrong resource by carrying the flat bias of a traditional farming operation into the thinking of nontraditional farming and growing designs. This is what is holding back the art of nontraditional farming and what holds mankind back in our journey to the planets and stars.

The realization that a vertical growing system is really an artificial tree, is then a first step in designing a better vertical growing system. Designs that can then mimic the actions of natural trees would be of great aid to many people. Professional farmers and growers and individuals that wish to have garden fresh food, will all be helped by designs that mimic trees.

### SUMMARY

The device in all its embodiments and aspects, is a device for growing plants in a similar fashion to a tree. The device reaches into three-dimensional space around the device, so as to capture the maximum available light, while still maintaining a relatively small footprint upon the ground.

### DRAWINGS

### Figures

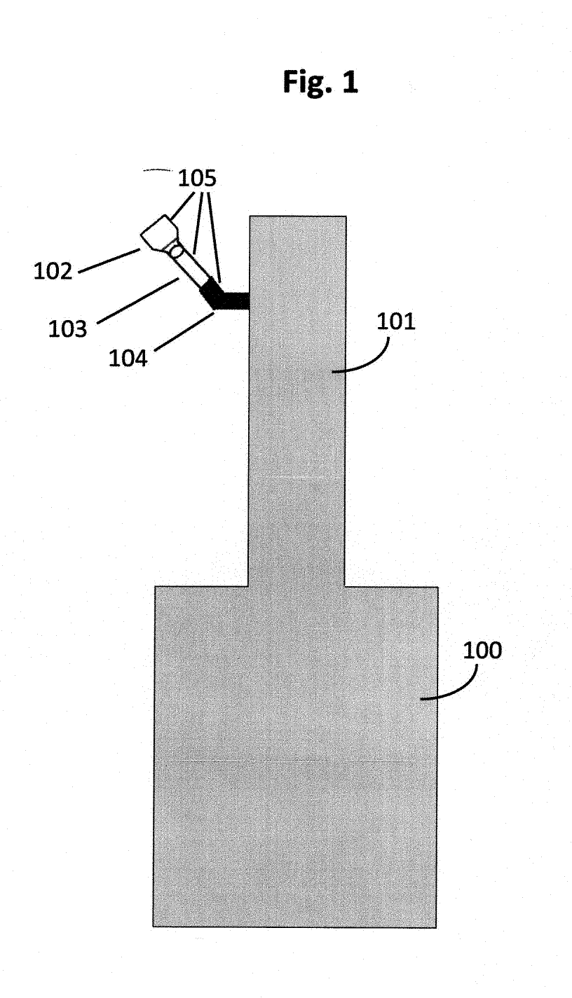

FIG. 1. Shows the common aspects of the devices.

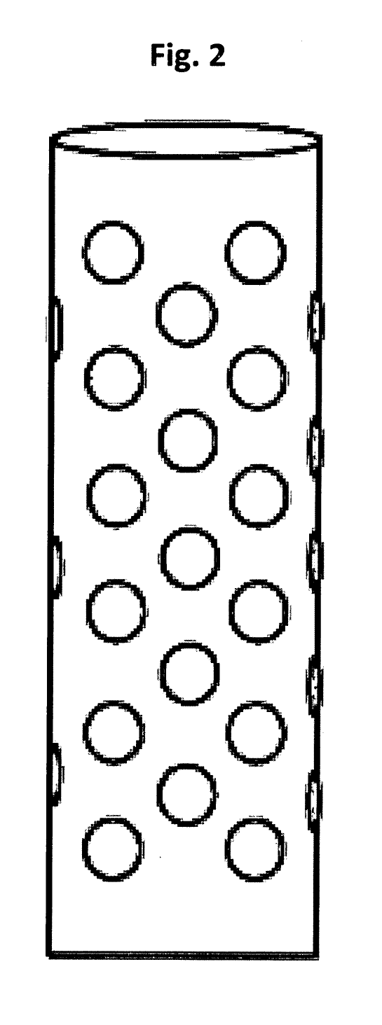

FIG. 2. Shows a vertical cylindrical tube containing a plethora of holes and herein referred to as a trunk, prior to the insertion of street elbows.

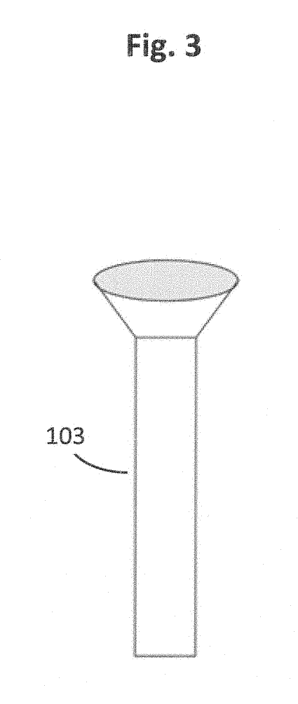

FIG. 3. Shows a branch tube with belled end.

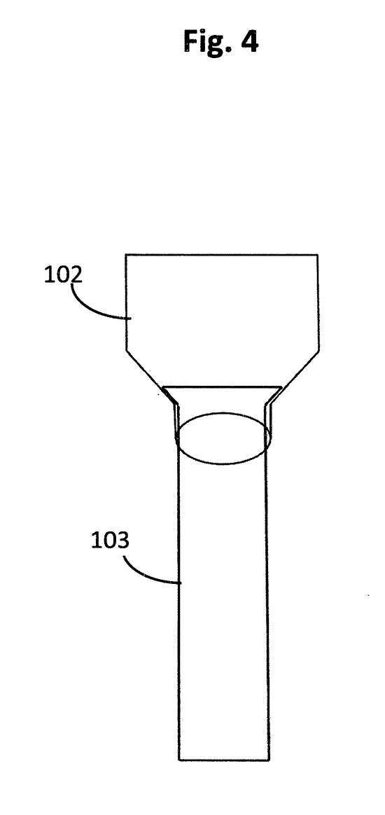

FIG. 4. Shows the branch tube with an attached grow bay.

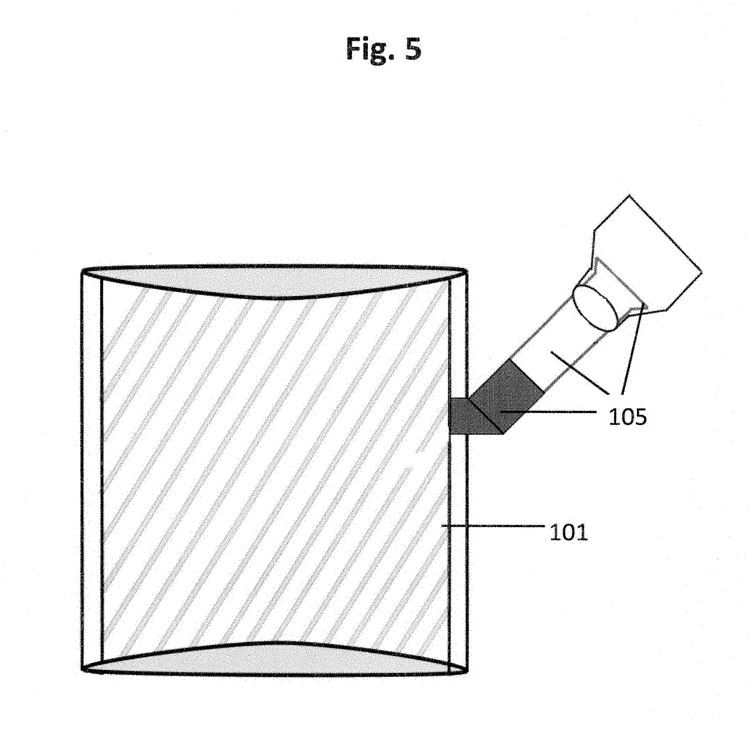

FIG. 5. Shows a close up of the grow bay, branch tube and a street elbow attached to the trunk, as used in aspects of the device and called herein a branch assembly.

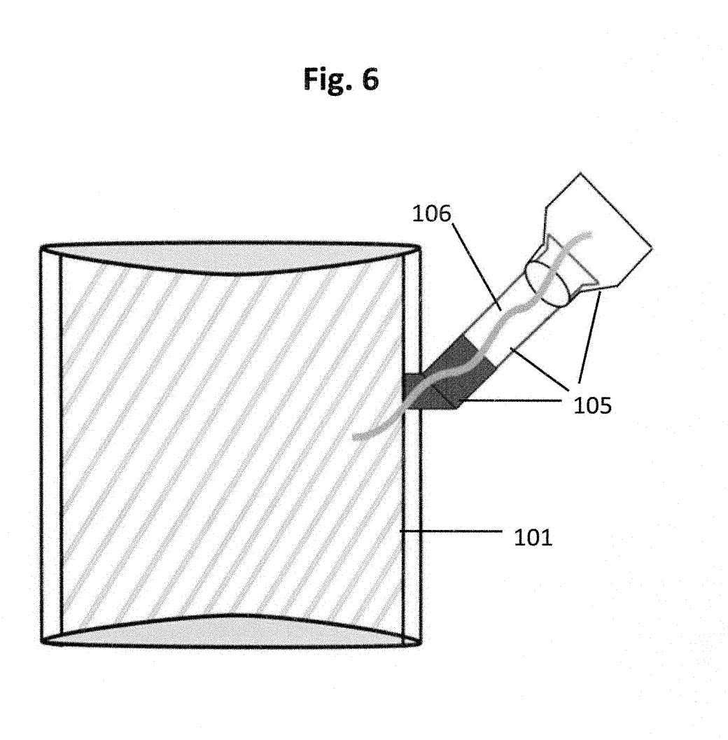

FIG. 6. Shows a close up of the branch assembly attached to the trunk, with a branch wick.

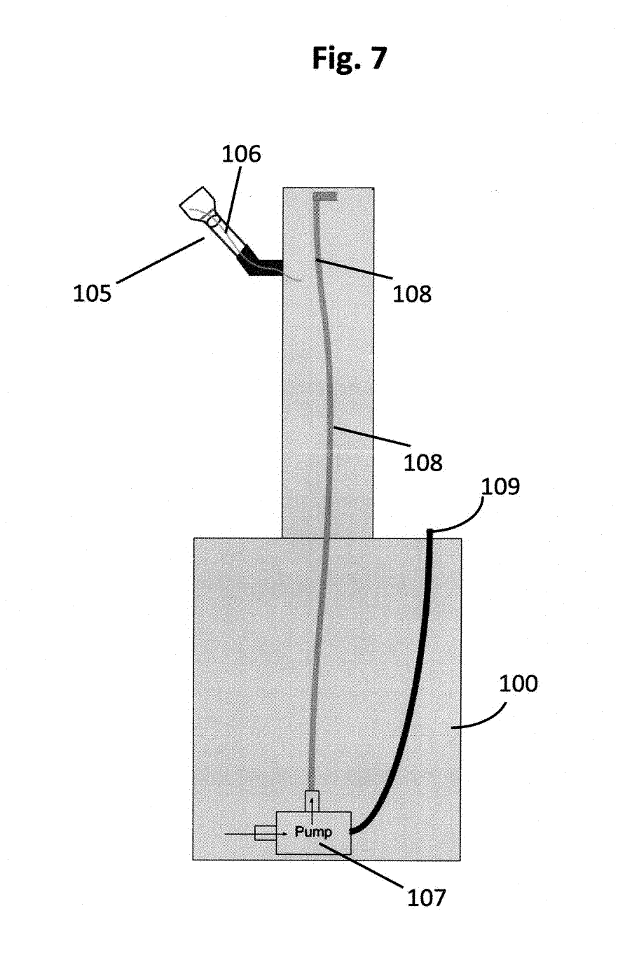

FIG. 7. Shows a first embodiment of the device, including a water pump and related tubing, using the branch wick for providing water to grow media.

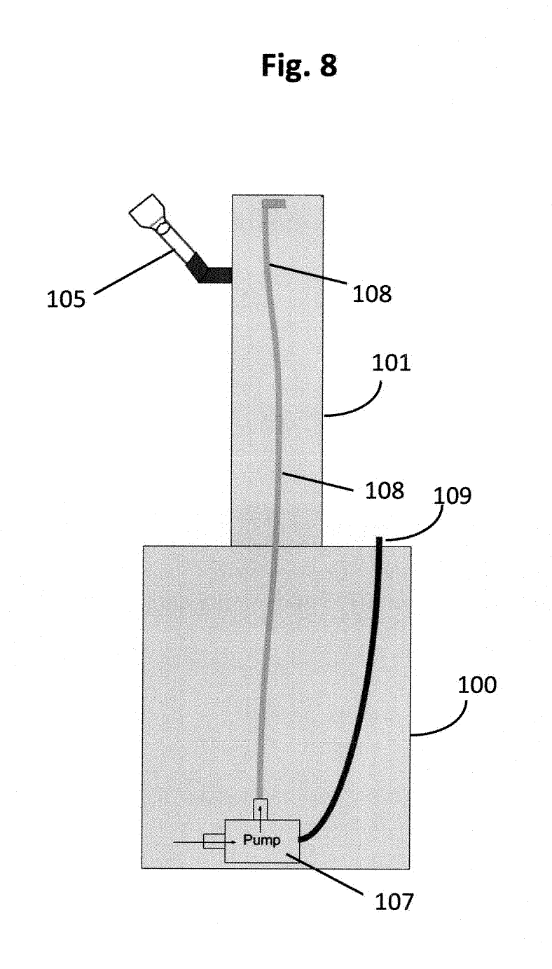

FIG. 8. Shows a second embodiment of the device, including the water pump and related tubing, as used for trunk flooding.

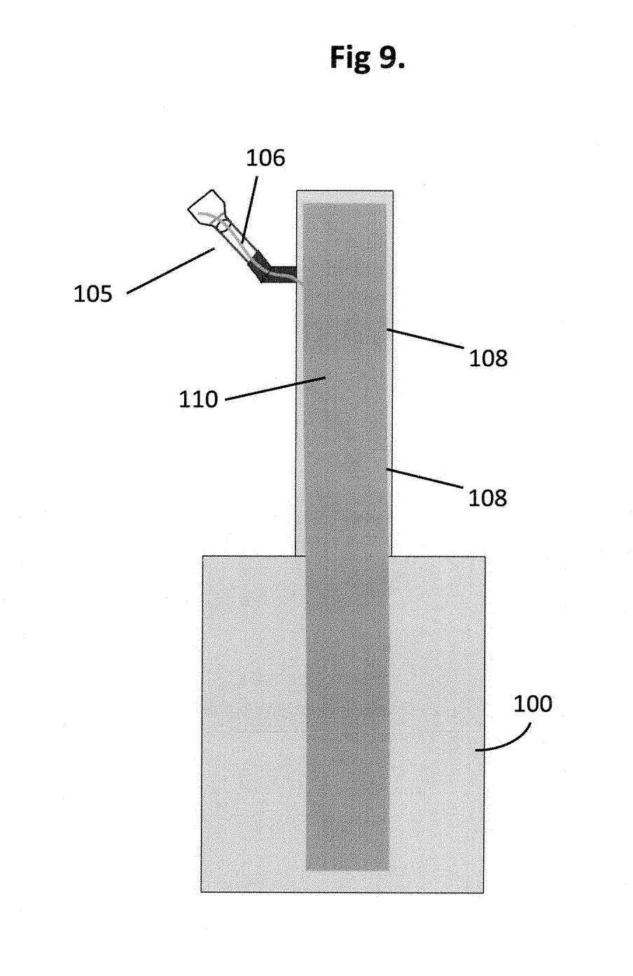

FIG. 9. Shows a third embodiment using a main wick and branch wicks, without the pump.

### Prior Art

FIG. 10. Shows U.S. Pat. No. 6,612,073, commonly sold as “MR.STACKY”

FIG. 11. Shows U.S. Pat. No. 6,840,008, a device using conically shaped plant pockets.

FIG. 12. Shows Great Britain Patent No. GB988458, a self watering pot using a wick to provide a constant source of moisture for the use of plants therein.

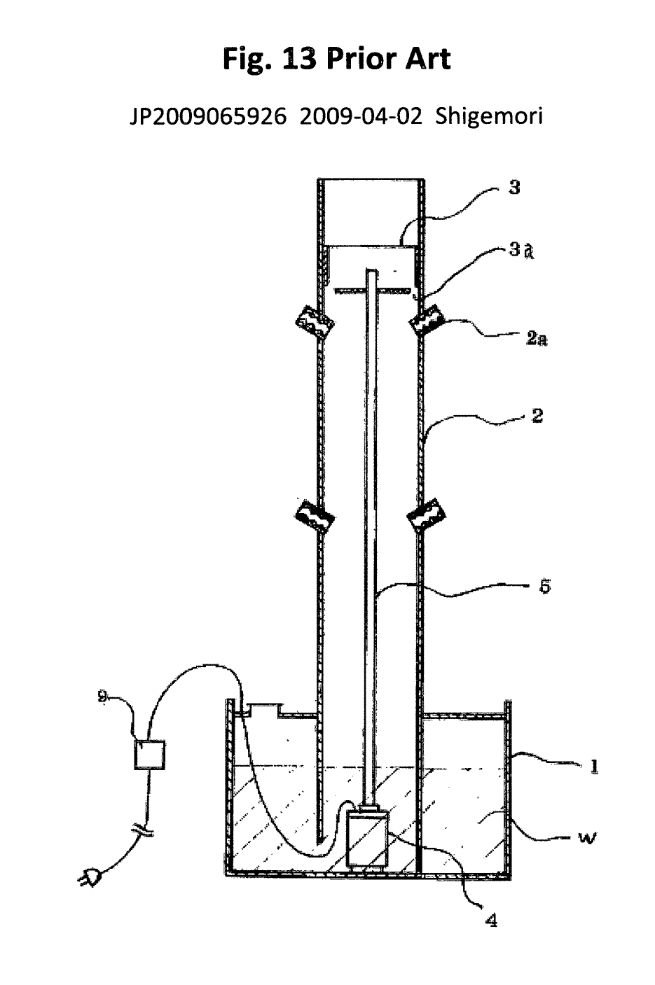

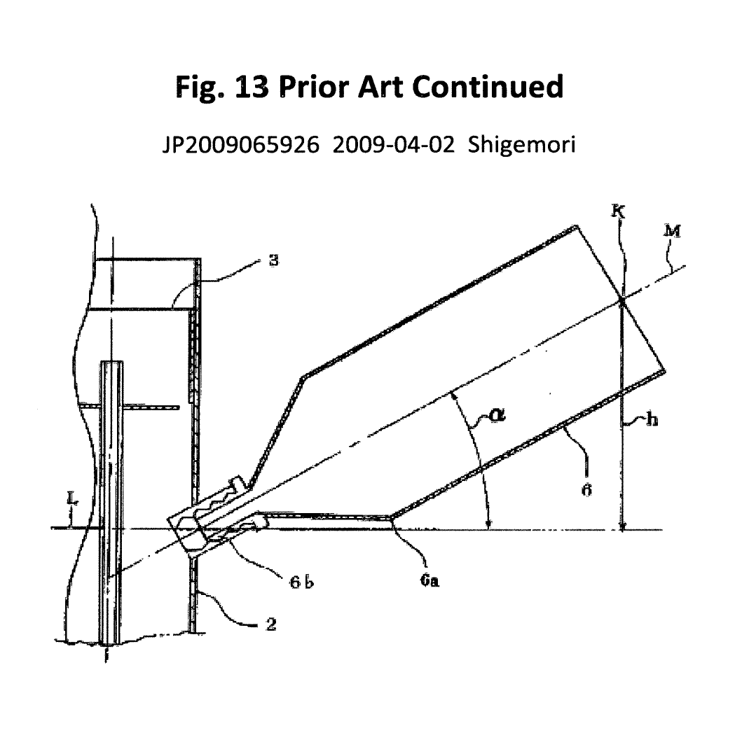

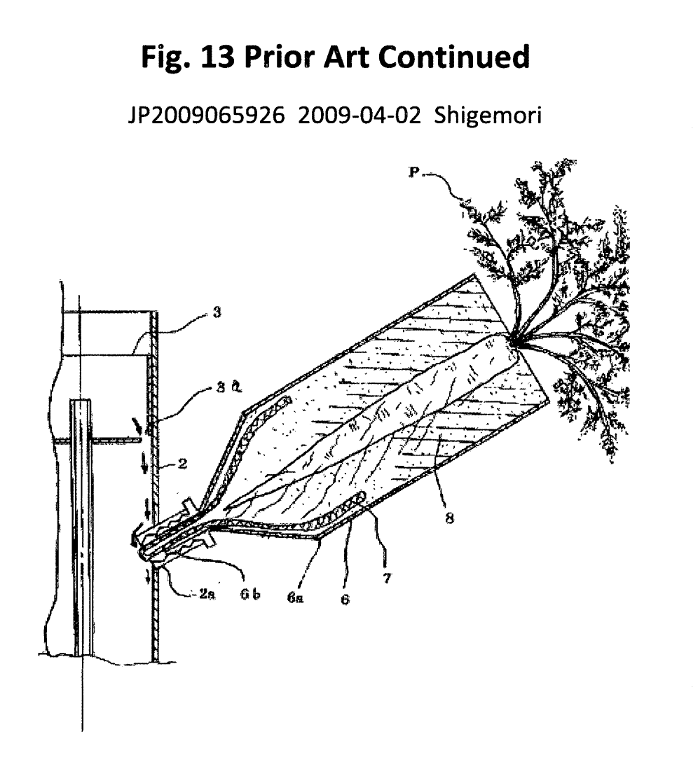

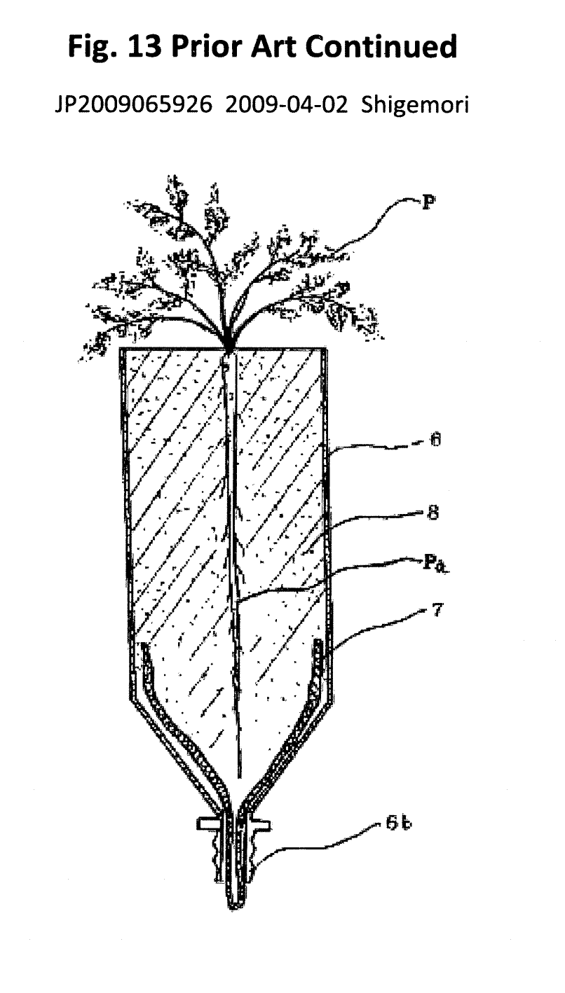

FIG. 13. Shows Japanese Patent No. JP2009065926, using PET bottles and wicks.

FIG. 14. Shows US Patent No. US2016/0135398, a device using plant receptors.

### REFERENCE NUMBERS

100 root bucket
101 trunk of system
102 grow bay
103 branch tube
104 street elbow
105 branch assembly
106 branch wick
107 pump
108 pump tube
109 pump wires
110 main wick

### DETAILED DESCRIPTION

The device is made to mimic the actions of a tree and certain descriptive language common to this understanding is used in this description. The device is made from the following materials and these materials are not in any way preferred, except that they are commonly available, inexpensive and rugged. Other materials may be substituted and not leave the spirit of the invention. Further, the lengths, dimensions and capacities are relative to the needs of the user and are not preferred lengths, dimensions and capacities. Lastly, there are multiple iterations of the device, resulting in multiple embodiments. No embodiment is preferred over another embodiment and their use depends upon the requirements of the user.

### Common Materials to All Embodiments

In general, all embodiments use the same system and materials as a base as described below. Small, but important additions and or subtractions are made to enable different embodiments for different needs and each embodiment will be described separately. Below are the elements common to all the embodiments.

A five gallon bucket, commonly available at a hardware store and sometimes referred to as a “five gallon paint bucket” is used as a reservoir for water. The bucket has a standard five gallon bucket lid upon it, in which a hole has been created. The bucket is akin to the roots of a tree, providing a stable base and conducting water and or nutrients to the system, just as a tree's root system does. The five gallon bucket is herein referred to as a root bucket 100 and is seen in FIG. 1. as numeral 100.

A PVC pipe of between 7.62 to 15.24 centimeters or three to six inches in diameter, is cut to a 1.524 meter or five foot length and is inserted through the hole in the lid of root bucket 100. The pipe then comes to rest upon the bottom of root bucket 100. Note that other sizes, shapes and materials may be substituted for the PVC pipe and these are already envisioned in this document. The pipe, regardless of dimensions or materials, is called herein a trunk. The trunk is seen in figure one as numeral 101 and forms the trunk of the artificial tree. In the bottom end of trunk 101 is a hole or holes, depending upon the needs of the user, that allows the easy passage of water back and forth from the interior of trunk 101 to root bucket 100. The portion of trunk 101 above the lid has a plethora of holes drilled in a geometric fashion, not unlike the many home made prior art devices well known to the art. The holes are evenly spaced in shifting rows, each taking advantage of the space left between the row above. The pattern is star like and can be seen in both the prior art and in the FIG. 2 drawing of this document.

The holes are drilled in a size to accept a standard, 1.27 centimeter, schedule 40, 45 degree PVC street elbows, commonly known as ½ inch, schedule 40, 45 degree PVC street elbows. These are generally available in plumbing and hardware supply stores. These are referred to as street elbow 104 in this document. Street elbow 104 has a female end and a male end. The male end is glued into trunk 101, with the female end pointing upwards. Street elbow 104 is affixed to trunk 101 using commonly available PVC solvent glues, available in plumbing and supply stores. The shifting pattern of street elbow 104 rises to nearly the top of trunk 101. Capping the top of trunk 101 is a standard end cap, commonly found in plumbing and hardware stores. (Note, the end cap is not shown in the drawings.)

Standard, 1.27 centimeter or ½ inch, schedule 40, PVC pipe comprises the branches of the tree in this system. They can be seen in FIG. 1, branch tube 103 and are seen close up in FIG. 3. Branch tubes 103 are cut to a 10.16 centimeter or 4 inch length, though shorter or longer lengths may be changed by the user and are dictated by the size of a grow bay, as explained farther on. Further, the material of PVC and the diameter are not preferred embodiments and any suitable material and or shape and or diameter may be substituted and is envisioned in this document. One end of branch tube 103 is heated with a hot air gun. The gun can be found in hardware stores and is commonly used in tile removal to melt the bonds of tile and linoleum. Once branch tube 103 becomes softened by the application of the heat, a file handle, broom handle or a wooden dowel with rounded end is inserted into the heated end of branch tube 103. This forces the PVC to flare outward, causing a bell like shape to form in the heated end. Any round piece of wood or other such material with a rounded end and a diameter of an inch or more will work. The size of the bell need not be much, as the bell need only be wider than the mouth of the bottle branch tube 103 passes through.

Water and soda bottles ranging from half a liter to two liters or larger are cut open on their bottom ends. Once cut, these bottles become grow bays in the system, and can be seen in detail in FIG. 4, numeral 102. Branch tube 103 is inserted into grow bay 102 from the now open bottom of grow bay 102. Branch tube 103 then passes through the mouth of grow bay 102 and the belled end wedges in the mouth of grow bay 102, as seen in FIG. 4. Grow bay 102 cannot then slip off the belled end of branch tube 103. The un-belled end of branch tube 103 is then inserted into street elbow 104. When branch tube 103 with grow bay 102 attached is inserted into street elbow 104, they form a branch assembly 105, seen in detail in FIG. 5. This ends the commonality of the device and specific embodiments will be discussed below.

### First Embodiment

The first embodiment may be seen as FIG. 7 and in addition to the common elements previously mentioned, a pump is at the bottom of root bucket 100. The pump is shown in FIG. 7, numeral 107. Pump 107 is powered by power wires that pass through the lid of root bucket 100. The power wires may be seen in FIG. 7 as numeral 109. When the proper voltage is applied to power wires 109, water will travel up a pump tube, as seen in FIG. 7 numeral 108. The water then hits the trunk cap and trunk 101 sidewalls, cascading back down the interior of trunk 101.

Strips of water absorbing cloth are cut to roughly 30.5 centimeters or 1 foot or more in length and up to 7.62 centimeters or 3 inches wide, depending upon the user's needs. Cotton may be used, as well as any other hydrophilic or water absorbing material. Common bathing towels were tested and found to be sufficient, but any material that conducts water will work. These strips are called herein branch wicks and referred to as numeral 106 in FIG. 6. Branch wick 106 is inserted into the open bottom end of grow bay 102 and then pushed down the inside of branch tube 103 until branch wick 106 exits the male end of street elbow 104 and into trunk 101. 2.54 to 5.08 centimeters or 1 to 2 inches of protrusion into trunk 101 is sufficient to conduct water and or nutrients along the full length of branch wick 106. Travelling the length of branch tube 103 is helped by pushing branch wick 106 with a wire coat hanger or other stiff device with a bit of give.

Grow bays 102 are filled with ordinary garden soil, common potting soil or any of the commercially available hydroponic medias. The many different types of soil and medias are referred to corporately as grow media in this document. A seed or seeds are then planted into the grow media near the end of branch wick 106. The seed or seeds will then grow naturally and follow the source of moisture down branch wick 106 and into street elbow 104, emerging into trunk 101. Moisture is maintained in the grow media and branch wicks 106 by applying voltage to pump 107 and causing water to travel up pump tube 108 to the top of trunk 101 and cascade downward upon branch wicks 106. This ends the description of the first embodiment.

### Second Embodiment

The second embodiment is identical to the first embodiment, except that there are no branch wicks 106. The system is instead watered by flooding trunk 101. A drawing of the embodiment can be found under FIG. 8. To flood trunk 101, a small hole and or holes are placed near the bottom of trunk 101. When voltage is applied to pump 107, water rises to the top of trunk 101 and cascades downward. Pump 107 will add water to trunk 101 faster than it drains out of the hole and or holes in the bottom of trunk 101, thus filling trunk 101 to the top. When water rises to top of trunk 101, the pump is shut off. The water then permeates into the grow media directly, soaking it as gravity tries to force the water outward. The density of grow media is sufficient to restrain water spillage and the hole and or holes in the bottom of trunk 101 drain the water away and back into root bucket 100. This ends the description of the second embodiment.

### Third Embodiment

The third embodiment replaces pump 107 and pump tube 108 with a long main wick that runs the length of the trunk and resides upon the bottom of root bucket 100. The main wick is shown in figure nine and given numeral 110. Water entering trunk 101 near its bottom and through the hole and or holes in trunk 101 is absorbed by main wick 110 and travels its full length. Branch wicks 106 then abut main wick 110 as it rises through the trunk. Moisture is transferred to branch wicks 106 and carried up branch tube 103 and into grow bay 102, as previously described in embodiment one. As a variation of the main wick embodiment, a long wick version composed of hydrophilic material running from each grow bay 102, down trunk 101 and all the way into root bucket 100 where it absorbs water, is envisioned.

### Operation

Operation of the device, in any embodiment, is simple. Operation of the three main embodiments is described separately for each main embodiment.

### Operation of First Embodiment

To operate the first embodiment, electricity is conducted to pump wires 109. Generally, a 12 volt pump is used, but other voltages may be applied to varying pumps. A session of 60 seconds of pump time will thoroughly wet the wicks. Electricity is then removed from the system and operation of the first embodiment is complete.

### Operation of Second Embodiment

To operate the second embodiment, electricity is applied in the same manner as in the operation of the first embodiment. Generally, it takes 2 to fill the trunk to the top. As the water fills the trunk, it attempts to work its way out of the trunk by force of gravity, thereby soaking the grow media.

### Operation of Third Embodiment

Operation of the third embodiment is automatic by design. Once filled with water, no further intervention by the user is needed, so long as the root bucket has water.

### Advantages

(a) All three embodiments use common, inexpensive, rugged and available materials to form the embodiments. The costs of these materials is low, especially when bought in bulk. They are easily repaired in the field. If not repairable, glue or even tape can be used to patch the system, leaving the other branches of the tree still useable. There are no parts available only from the manufacturer and therefore no monopoly is formed.

(b) The system is as easy to maintain in a single instance, as it is in a large, multiple unit, professional growing system. The system uses very little water, needs no additional support in the form of large pumps, mixing tanks and other expensive systems and does not need to be suspended from overhead, though it certainly could be. What water it does use, can be easily replaced using a common water hose or bucket, as in the case of a single unit. Therefore the system is as useable to a person living in a poverty stricken nation as it is to the professional grower in a massive growing operation. The system further eliminates the back breaking labor of a garden, while keeping all of the psychological and health benefits of a garden. Children, the handicapped and the elderly can easily garden now and reap the benefits of fresh food. Transportation loss is ended and the shelf life of produce is greatly increased.

(c) The system is at just as useable in a greenhouse as it is in a home, outside in a yard or on a patio. Since all water is contained in the system, a corner of the house, a basement or a spare room may become an impromptu greenhouse for indoor growing. And since no external devices are needed, it may be easily concealed. This unique ability means the system and its food are resistant to destruction, theft and confiscation. In areas of the world where food is used as a weapon, this is a considerable advantage. Further, the trunk can be removed from the system, whilst leaving the plants unharmed. Moisture is maintained for days in the grow media and or branch wicks and trunk just by simple evaporation and condensation within the system. This is critical to moving the system in times of war, famine or displacement by natural disasters or if a grower needs to transport systems from an outdoor growing environment to a greenhouse, etc.

(d) The system, in all its embodiments, is designed to grow from seed to harvest, without the aid of additional devices for seedlings and then juvenile plants. The resulting labor savings and equipment savings is substantial.

(e) The systems unique design using the branch tubes is the same thinking as the designer of a tree. This artificial tree design approach reaches from the inside outward, not the outside inward. The truly valuable resource to any plant is the sunlight obtained by reaching outward. This then is a total departure from the thinking of previous systems. The prior art feels that the resource of water and or nutrients in the central tube of the system are of the greatest importance. Access to light around the system is at best an afterthought—if thought of at all.

(f) The design of this system drastically reduces the need for chemicals of any kind. If they are needed, they are added and contained within the system. No longer will fertilizer, weed killer and insecticides drain into our rivers.

(g) With some minor modifications, the system could be used in very low to no gravity environments. The moon and Mars are available to us—if we can farm there. This system is certainly useable in low gravity environments like the moon and Mars. One may even send an automated version of this system to Mars, ahead of an actual mission and ascertain if Mars can indeed support vegetable life as is. Successive systems could then be designed and sent to Mars, improving upon the design until a sure and stable food system is assured. Future Astronauts will know that the farming systems they bring will not only work on Mars, but will provide the freshest of foods on their long journey.

(h) Further, the system could be suspended from a central spoke in the center of a spacecraft, not unlike the spokes of a wheel. In zero gravity, the wheel is gently spun. As the rate of spinning increases, so will the gravity in each system. It should then be easy to add grow media to the grow bays and plant seeds in the grow media. With artificial lighting, the entire system is set to provide food for the journey to Mars and back- or to a new home in a foreign solar system. This then allows a dramatic decrease in weight, as the system essentially is an energy to matter converter, taking energy generated from the light of the ship and creating matter in the form of food. Since great deals of heat and electric energy can be generated from a tiny mass, this solves the problem of storing food for a space journey. Biological wastes are then converted back into food, forming a circle—just as it does on Earth.

(i) The system lends itself to tool assisted harvesting. The branch assemblies are easily pulled away from their slip fit in street elbows with pliers or a custom made tool. Additionally, the entire “tree” may be pulled from the root bucket and manually or mechanically lifted to a harvesting system for workers. Further, the slip fit design of the branch assembly allows for robotic harvesting, as branch tubes with grow bays attached, may be easily found by a robotic device and lifted from the street elbow, without damage to other plants.

(j) The system deeply lends itself to mass production methods and ensures that the cost of the system can be kept low. This means that even the poorest of peoples living in near dire circumstances, can afford to have fresh food. This IS the way to prevent malnutrition, even starvation. This IS the way to introduce the best dynamics of capitalism to people who barely have clothing upon their backs. People caught up in wars, government upheavals, famines, disasters that are natural or manmade or simple disruption of transportation networks, will still be able to harvest food from this system. This will see them through the upheaval and to the restoration of normal food deliveries.

(k) In our modern times, nations are truly vulnerable to a phenomenon known as Electro Magnetic Pulse. EMPs can be naturally generated by the sun or manmade by an atomic detonation in space. This system contains no vulnerable electronics to be destroyed by an EMP event.

(l) Automated growing is easily accomplished with this system. A solar cell and a simple computer control system may be added. There are many microprocessor devices that can be used to control the system; like the Arduino, Raspberry PI and many others. All are adaptable to this system with simple sensors. Sensors for soil moisture would send a notice of dry grow media before the plant is triggered to stop growing. The system could then trigger the pump, as in two of the embodiments, or notify the user that something is wrong, as in the main wick embodiment. The user may further access these computers wirelessly, checking upon water levels, temperature and many other statistics important to growing.

(m) It should be noted that if plants face a particularly cold time, such as at night, the water pump can be run continuously during the day, soaking up heat from the sun. The pump can then be triggered to run by the microcontroller in response to cold temperatures, essentially ensuring that a cold snap does not kill the plants. And of course the user may access this data about their plants via the internet. Cameras can even be installed, allowing a user to check the progress of each “tree” in their “forest” from a central location.

### CONCLUSION, RAMIFICATIONS AND SCOPE

Accordingly, the reader will see that the device in its embodiment and or embodiments, are plant growing machines that mimic the design of a tree by artificial means. They provide a farmer, grower or gardener with a way to grow in any environment that can support plants with a modicum of water and resources.

They allow medical and biotech companies a way to grow many plants in a small space while tracking each plant with identification markings on the branch tube or by means of a small RFID device attached to the branch tube or inserted into the grow bay with the plant and or grow media. Since the entire branch tube and grow bay can be removed as a unit, traceability is easily maintained. This ability should not be overlooked, as biotech and agriculture developers need such systems.

Further, the ability to be repaired with common, inexpensive materials and their construction with these same materials, is a huge boon over existing systems that require materials only available from a particular manufacturer. This also makes the system easy to adapt to various needs and to experiment with. This flexible ability could well see a dramatic increase in experimental growing of plants, as the system can be adapted to large plants and small, by changing the size of the grow bay and the branch tube and by using a larger diameter branch tube. A larger or smaller diameter branch tube can be easily added to the system with a common plumbing adapter—without switching the size of the street elbow. For instance, a system made in one inch street elbows for large, heavy plants, can be adapted to work with small plants by the simple addition of a reducer bushing. Likewise, a system made with half inch street elbows can be changed to hold longer branch tubes and heavier grow bays with the addition of a simple, off the shelf adapter. These are common plumbing fittings found in nearly any hardware or plumbing supply store. Even in the poorest regions and countries, such materials are still available. This ability should not be overlooked, as it is a major advantage over all other systems.

Further, the system capacity can be dramatically increased by using Y adaptors that double, even triple the capacity of any given branch assembly.

The ability to easily repair the system with glues and off the shelf parts, should not be overlooked. If a branch assembly breaks or is otherwise lost, the hole may be plugged or even taped over, without affecting the operation of the rest of the system. This is truly a boon.

Although the descriptions in this document contain specifications, they should not be construed as limiting the scope of the embodiments, but as merely providing illustrations of some of the many different embodiments possible with this system. Thus the scope of the embodiments should be determined by the appended claims and their legal equivalents, rather than by the examples given.

I claim:

1. An apparatus for growing plants, the apparatus comprising: a hollow tube or solid rod of any practical shape, design, size or material, used to extend a growing bay into three dimensional space, so as to gain said space and or the access to light in said space for the plant and or plants to grow.

2. The apparatus of claim 1, said tube being hollow and allowing the transmission of water to the growing bay from a water source.

3. The apparatus of claim 1, said tube allowing the lifting of a growing bay to gain said space.

4. The apparatus of claim 1, said rod allowing the lifting of a growing bay to gain said space.

5. The apparatus of claim 1, said tube or rod having a belled or otherwise expanded shape at the end to prevent the slippage of any container used as a growing bay; regardless of size, shape, material or the original purpose of said container used as a growing bay.

6. A system for growing plants, comprised of a hollow tube having a wick made from water absorbing material traveling down its length, in order to conduct water to the growing bay at the end of the tube and said wick exceeding six inches at its shortest length.

7. The system of claim 6, and a second water absorbing material traveling from a reservoir of water and or nutrients and then touching said water absorbing material from claim six so as to eventually transfer water and or nutrients to the growing bay.

8. The system of claim 6, extended over a long length and leading directly to the reservoir of water and or nutrients so as to eliminate the need for a second water absorbing material in claim 7.

9. The system of claim 6 without the wicks and the addition of a water pump used to flood the entire trunk, thereby using the force of gravity and or the absorbency of soils, and or any media used to grow plants, to supply a plant and or plants with water.

10. A method for watering plants by flooding a central chamber that the plants and or grow bays are attached to, so as to use the force of gravity to water plants or grow bays and their grow media.

11. The method of claim 10, flooding the chamber with a water pump, said chamber having hollow tubes attached, so as to use the force of gravity to water plants or grow bays and their grow media.
